(19) United States
(12) Patent Application Publication
(10) Pub. No.: US 2026/0035219 A1
(43) Pub. Date: Feb. 5, 2026

(54) Portable Winch and Bollard Device

(71) Applicant: Nathan Hill, Thorntown, IN (US)

(72) Inventor: Nathan Hill, Thorntown, IN (US)

(21) Appl. No.: 19/287,638

(22) Filed: Jul. 31, 2025

Related U.S. Application Data
(60) Provisional application No. 63/679,158, filed on Aug. 4, 2024.

(51) Int. Cl. B66D 3/20

(52) U.S. Cl. CPC B66D 3/20; B66D 2700/0191

(57) ABSTRACT

A portable self-tailing winch and rigging bollard device that contains a self-tailing winch and a rigging bollard that are permanently fixed on a rigging plate. Other options include fairleads for rigging lines and ports for additional rigging attachments. The rigging plate is portable and can be easily anchored to any suitable structure located either inside or outside of a building. The self-tailing winch and rigging bollard can be operated by a single individual to control the tension of rigging lines for safely re-positioning or holding a load. For optimal safety, both the self-tailing winch and rigging bollard are fastened to the load and synchronously operated with fairleads to maintain or alter position of the load to a desired location.

### FIELD OF INVENTION

A portable self-tailing winch and rigging bollard device anchored to a structure and employing a system to control tension of rigging lines for safely re-positioning or holding a load.

### SUMMARY OF THE INVENTION

Winches are used across diverse applications for lifting or pulling heavy loads. The basic mechanism of the winch consists of a spool or drum where a line or cable winds around the drum and the other end is fastened to the load to be moved. The line or cable is either tensioned or released from the drum using a handle or a powered motor to move the load. Often in industrial and maritime contexts, winches and bollards are used to provide a strong anchor point for securing rigging lines or cables. Bollards are successfully utilized to provide variable friction to lower lines under heavy load while winches provide the mechanical power to tension lines and to lift loads. A significant problem encountered with winches is that, while being efficient in the tensioning of lines and lifting of loads, they can be dangerous in the releasing of lines under extreme load. The indiscriminate removal of wraps of line from around the winch drum to release tension have in some cases allowed the winch to unspool, causing an uncontrolled free-fall of the load. Bollards in combination with a winch act to safely prevent an undesired release of the tension in the line leading to a potentially dangerous fall of a heavy load. Such applications are useful in industries like construction, marine, automotive, aerospace, entertainment, mining, or any external or internal environment to move loads efficiently and safely.

Current mountable rigging devises utilizing winches tend to be of excessive weight and cumbersome to transport and to set up in the field where needed. It would be advantageous to a user if a single portable winch system could offer a balanced contrast of elements consisting of sufficiently weighted metal materials that have the required structural toughness such as tensile, compressive, shear, yield, fatigue, and impact strength. The present invention has improvements that balances all these elements and are implemented in a novel way.

A portable and anchorable device to tension and release the tension of ropes under load is critical to the safe execution of rigging operations. Tension introduces force into a rope to move or hold an object against the force of gravity. A controlled release of tension from the rope is then required when the movement of an object is completed, or it is no longer necessary to hold an object in place. Various tools are utilized to address these two separate forces in rigging operations. Bollards are successfully used to provide variable friction to ropes to hold and/or lower attached objects; winches are used to tension ropes and lift attached objects. It is advantageous that a portable rigging device includes both elements (bollard and winch) to address these forces simultaneously or separately and provide an anchorable platform consisting of structurally tough materials, while remaining lightweight for transport.

The preferred components of the portable self-tailing winch and rigging bollard device described herein include a self-tailing winch, a rigging bollard, and a rigging plate having eyelets available for anchoring the device to structures. A novel feature of the portable self-tailing winch and rigging bollard device is that it is designed to operate as a single unit that includes all key rigging elements to ensure structural toughness, reduced weight, and ease of use. Some aspects of portable winch devices include a self-tailing mechanism on top of a rotating drum which automatically holds and advances a line through the drum while being rotated. The line from the drum of the self-tailing winch may then be passed around the rigging bollard for additional friction and security. A rigging bollard is a cylindrical post, either hollow or solid, of various width and height used to provide sufficient friction to a loaded line by wrapping the rigging line around the bollard. The wraps of line can either be added or removed from the rigging bollard to adjust the friction applied to the rope. Additional tension security for a rigging line resides in one or two horizontal posts through the bollard, which are used to secure the line when not adjusting tension. The rigging bollard also provides an anchor point for the line exiting the self-tailing winch to the load for securing ropes while managing loads during rigging operations to include: raising, lowering, holding in place, or adjusting the positions of object/s to be moved. The rigging plate or backplate is used as the anchoring platform for securing the portable rigging device through openings or eyelets in the plate as a means of anchoring the devise to desired structures.

The surprising function of the single rigging bollard and self-tailing winch system is that they may be used together or independently while operating the device. This operation is due to other critical components of the self-tailing winch and rigging bollard device that include the use of one or two fairleads that are fixed on the rigging plate and act to position the rigging lines to either the self-tailing winch or rigging bollard. In the novel aspect of this device, the inclusion of two fairleads on opposite sides of the rigging bollard facilitates the separation of two rigging lines to either the self-tailing winch or the rigging bollard, which permit independent use. Their dual operation enhances its operational safety, particularly for only a single operator. First, the rigging line separation stops the entanglement of the lines going to both the self-tailing winch or to the rigging bollard during operation, which are aligned directly above or below the other. The fairleads orient either rigging line to align away from rigging bollard by routing the rigging line to the outside of the fairlead. Second, and more importantly, two distinct rigging lines may be used simultaneously in the device. One fairlead appropriately aligns a line with the bollard, the second fairlead appropriately aligns a second line with the self-tailing winch. Any unexpected unspooling of the winch under load may be backed up by the line on the bollard. Both lines may also operate independently, with the first rigging line on the self-tailing winch tensioning the line, while the second rigging line running to the bollard is held in place or tension in the line is released. In this function a single load with two rigging lines attached may effectively be balanced by either tensioning or releasing tension from either the self-tailing winch or bollard.

### BRIEF DESCRIPTION OF THE DRAWINGS

FIG. 1 illustrates angled view of the self-tailing winch and bollard device.

FIG. 2 illustrates front view of the self-tailing winch and bollard device.

FIG. 3 illustrates right side view of the self-tailing winch and bollard device.

FIG. 4 shows two views of the rigging line 9a tension points during operation. The upper panel shows the front facing aspect of rigging line in the self-tailing winch and bollard device when anchored to a tree. The lower panel showed the left side view of the rigging line from the load to the self-tailing winch drum.

FIG. 5 depicts the self-tailing winch drum and jaw mechanism.

FIG. 6 shows two views of the rigging line 9b tension points during operation. The upper panel shows the front facing aspect of rigging line in the self-tailing winch and bollard device when anchored to a tree. The lower panel showed the left side view of the rigging line from the load to the rigging bollard.

FIG. 7 illustrates two views of both rigging lines in operation. The upper panel shows the front facing aspect of both rigging lines to the self-tailing winch and rigging bollard when anchored to a tree. The lower panel shows the left side view of both rigging lines from the load to the self-tailing winch and rigging bollard.

FIG. 8 shows two examples of anchoring the rigging plate to a tree. In upper panel shows a side view of the rigging plate anchored to the tree using straps attached to the eyelets at the midpoint that pass around the tree. In lower panel, the rigging plate is further secured to the tree using an anchoring line through an eyelet at the bottom of the rigging plate.

### DETAILED DESCRIPTION OF INVENTION

### Definitions

Rigging bollard is a hollow or solid, fabricated metal tube that is between one-half to twice the height of the self-tailing winch. and the circumference is between one-half to twice that of the self-tailing winch drum.

Fairlead is an open metal hook or loop for guiding rigging lines, distributing tension, and positioning rigging lines between the bollard, the winch, and the load to be moved.

Self-tailing winch is a winch that automatically grips and tensions a rigging line and can be operated by one person to crank the winch and manage the line for moving a load.

Rigging line is a rope or cable capable to withstand significant weight and force when used in conjunction with the self-tailing winch, bollard, and other rigging components to move and position a load.

Rigging plate is the base for the attachment of the self-tailing winch, rigging bollard and other rigging components and for anchoring the entire device to a structure.

While the terms used herein are believed to be well understood by one of ordinary skill in the art, definitions are set forth herein to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the embodiments.

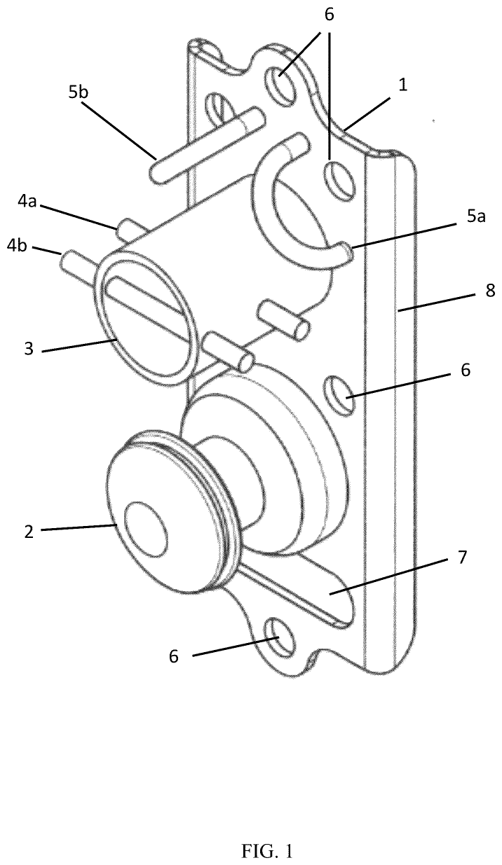

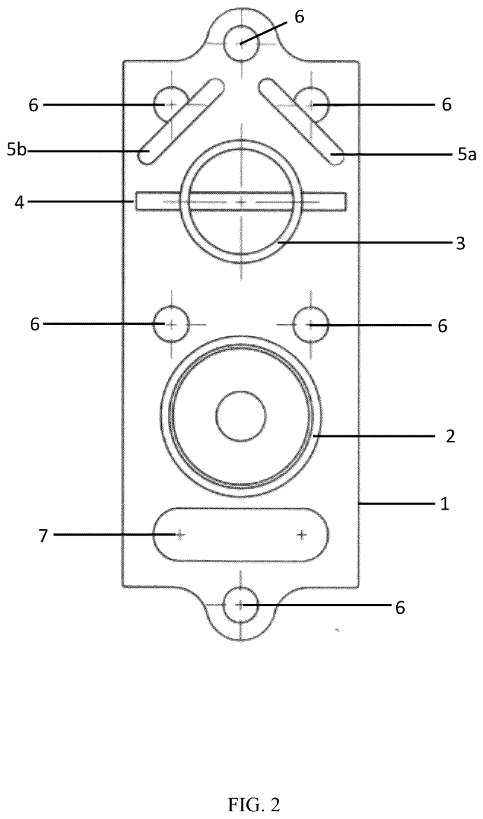

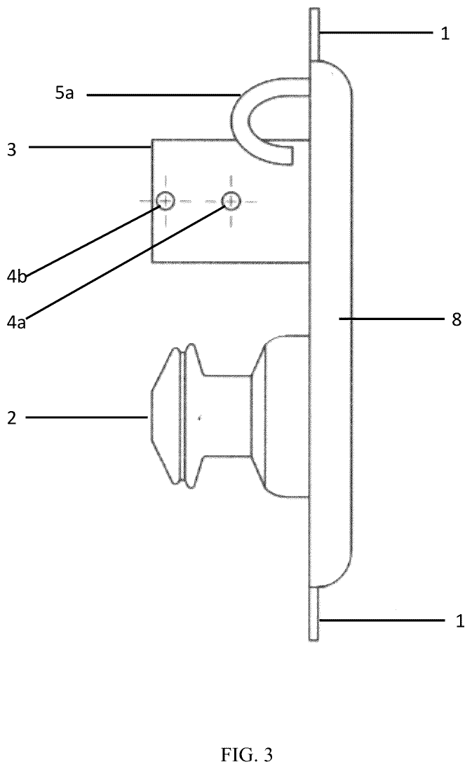

FIG. 1 shows a typical embodiment of the self-tailing winch and rigging bollard device that is anchored to a structure for moving a load from its current position to a desired position. The embodiment in FIG. 1 shows the possible components of self-tailing winch and rigging bollard device is illustrated in an angle offset view. FIG. 2 and FIG. 3 depict a front view and a right side view, respectively, to further illustrate the components. Referring to FIGS. 1-3, the preferred components of the winch and bollard device include a self-tailing winch 2 and a rigging bollard 3 that are attached to a rigging plate 1. Depending upon the use of the winch and bollard device, the rigging components in FIG. 1 include one or more posts 4 horizontal to the rigging plate 1 across circumference of the rigging bollard 3. In addition, one or more fairleads 5 adjacent to the rigging bollard, preferably in an angled position. Other preferred components include one or more eyelets or openings 6 in the rigging plate for anchoring the rigging plate to the structure or for attaching rigging accessories to the rigging plate. An optional component in the rigging plate includes a hand port 7, an oval or slot opening, for easy transport of winch and bollard device, which can add an additional opening for either anchoring or attaching accessories.

Referring to the preferred components of the winch and bollard device in FIG. 1, the self-tailing winch 2 and rigging bollard 3 are permanently fixed to the rigging plate 1 to ensure structural integrity of the device. The rigging plate 1 is made of metal and, preferably, made of steel or titanium that are superior to other metals in tensile, compressive, shear, yield, and other structural strengths. In early observations using aluminum as the metal for either the rigging plate or rigging bollard, it was observed that although aluminum was lighter weight, it suffered from either bending or shearing under a sustained heavy load. The thickness of the metal rigging plate 1 is at least 0.25 inch. Steel types includes, but are not limited to, stainless steel, carbon steel, galvanized, alloy, and steel variations thereof. The longitudinal edge of the rigging plate is designed for increased flexibility for anchoring on irregularly shaped surfaces of the structure. In the preferred embodiment in FIG. 1, the longitudinal edges 8 on either side of the rigging plate are rolled backward between 35 to 90 degrees. In addition to increased anchoring flexibility, the longitudinal edges 8 of the rigging plate raise the rigging plate 1 surface off the surface of the anchoring structure to protect the bolt attachment points on the reverse side of the rigging plate 1. The preferred depth of the longitudinal edge 8 is at least 0.25 in. Both sides of the longitudinal edges 8 can be optionally serrated to provide better gripping to the structure, not shown in FIGS. 1 and 3.

The attachment of the self-tailing winch 2 to the rigging plate 1 is performed by either welding the winch to the rigging plate or drilling holes in the rigging plate depending upon the number of holes in the self-tailing winch, typically 2, 3, 4 or more, and secured using metal bolts. A self-tailing winch 2 in FIG. 1 is selected based upon its weight for portability and the weight of the load to be moved, ranging from 20 lbs to 2000 lbs. The winch size is selected based upon multiplying the load to be safely moved by 2:1 to 40:1. The preferred power rating of self-tailing winches for portable use in these embodiments range from 15 to 40. Examples of power ratios include, but are not limited to, Harken radial 20 self-tailing winch, Lewmar 30, Harken 35, Harken 40, and other similar sized manufactured winches.

The attachment of a hollow or solid, round rigging bollard 3 to the rigging plate 1 is performed by welding the bollard in the perpendicular position to the rigging plate. The rigging bollard 3 is made of metal and, preferably, steel or titanium. The thickness across the metal tube wall of rigging bollard 3 is at least 0.125 inch. As illustrated in FIG. 2, the rigging bollard 3 is placed directly above the self-tailing winch 2. In other uses, the rigging bollard 3 is placed below above the self-tailing winch 2. The position of the rigging bollard 3 is located either above, as shown in FIG. 1 and FIG. 2, or below of the self-tailing winch 2 relative to the orientation of the rigging plate 1. In preferred embodiments, the spacing between the self-tailing winch 2 and the rigging bollard 3 is at least the diameter of the rigging line 9, shown in FIG. 2.

In further embodiments of the rigging bollard 3 are presence of one or two or more horizontal bollard posts, depicted as two posts, 4a and 4b, in FIG. 1. The horizontal bollard posts 4 are made of metal such as steel or titanium. The rigging bollard 3 is horizontally drilled through both sides of the bollard. Horizontal posts are either permanently attached by welding or threaded through the opening on either side of the bollard. If two horizontal posts are present, the space between the horizontal bollard posts 4a and 4b, is at least the diameter of the rigging line, and preferably, two to three times the rigging line diameter allowing for at least 3 wraps of the rigging line. Longer bollard tube heights are optional to accommodate for addition space for rigging line wraps.

Other preferred embodiments, referring to FIG. 1, a hooked or u-shaped, open fairlead 5, and typically two fairleads, are positioned with the hook facing away from and adjacent to the rigging bollard 3. Fairleads 5 are made of metal, preferably steel or titanium. A fairlead 5 is positioned on the rigging plate 1 between 0°-90° outside of the rigging bollard 3, preferably between 30°-75°, with the hook facing away the bollard, and at least the distance of diameter of the rigging line 9, and preferably two to three times the rigging line diameter to align the rigging line from the rigging bollard 3 to the load. The distance between the rigging plate 1 and a fairlead 5 is at least the distance of diameter of the rigging line 9. The rigging line is rope, cable, wire, strand, lanyard, or similar material that is round shape and having a strength of supporting at least the heavy load. The diameter of the rigging line 9 ranges from 1/16 in to 1.5 in, depending upon the weight of the load.

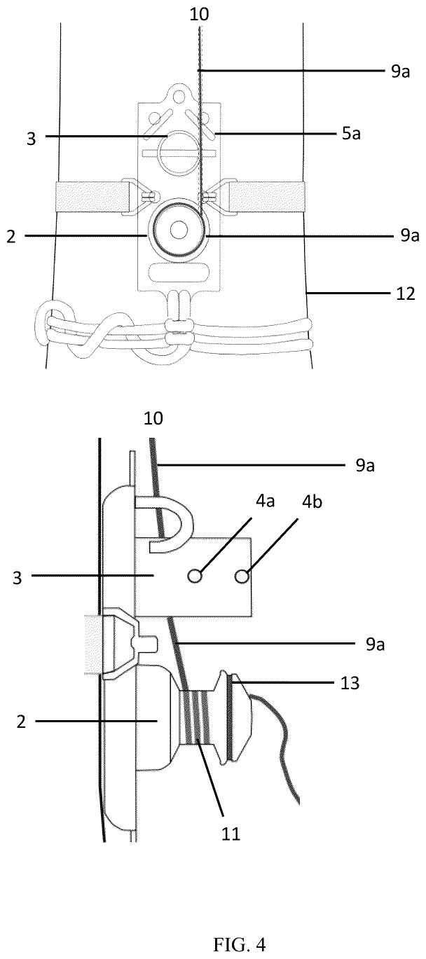

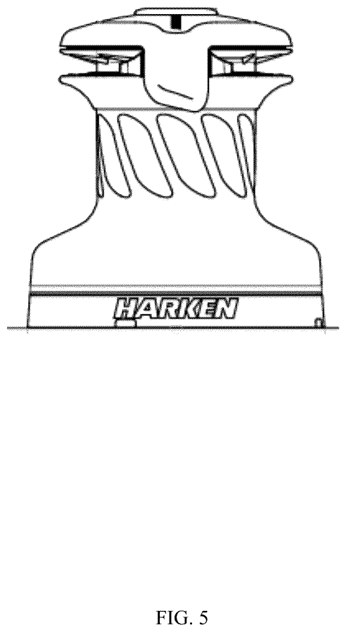

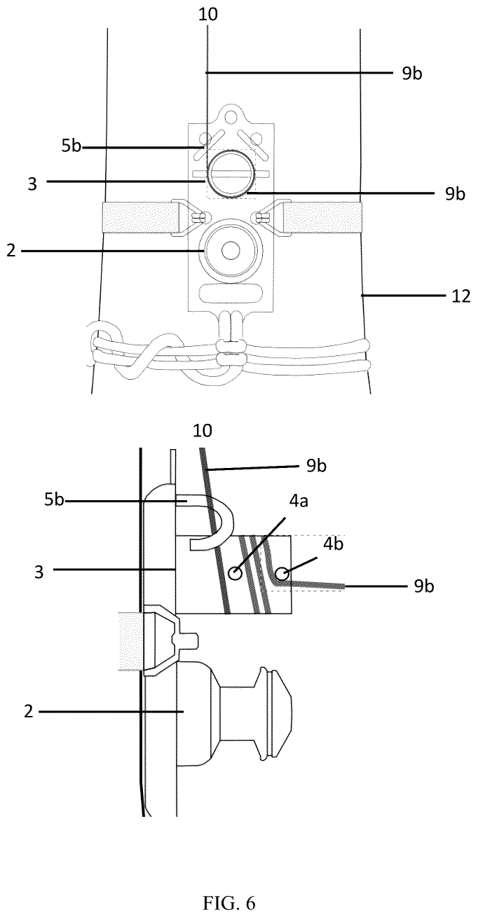

The self-tailing winch and rigging bollard device preferably include rigging components used for control of the tension of rigging lines in conjunction with the self-tailing winch and rigging bollard as shown in FIG. 4. As illustrated in FIG. 4, starting from the load 10, the main rigging line 9a is routed outside the fairlead 5a and the rigging bollard 3 to the self-tailing winch 2. In FIG. 4, routed to self-tailing winch 2, the main rigging line 9a is wrapped around the drum 11 of the self-tailing winch 2 and inserted in its jaw mechanism 13 (FIG. 5) of the rigging winch 2 and set. After setting the self-tailing winch is used to either raise, hold or lower the load 10. In further illustrations in FIG. 6, starting from the load 10, a secondary rigging line 9b is routed outside the fairlead 5b and the rigging bollard 3 and underneath the main horizontal post 4a. The secondary rigging line 9b is wrapped around the rigging bollard 3 between the main horizontal 4a post and the secondary horizontal post 4b, and optionally secured, for example with a lighterman's hitch knot.

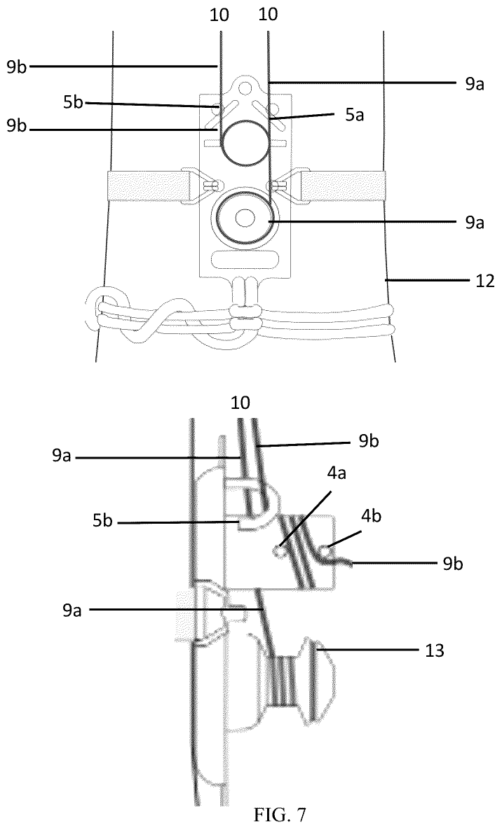

In certain applications, both fairleads are employed to provide additional safety to the user. In FIG. 7, two rigging lines 9a and 9b are independently used. In FIG. 7 the main rigging line 9a from the load 10 is routed outside a fairlead 5a and the rigging bollard 3 on the same side of where main rigging line 9a is routed and wrapped clockwise around the self-tailing winch 2 drum. In FIG. 7 a secondary rigging line 9b is routed outside a fairlead 5b and the rigging bollard 3 on the opposite side of the main rigging line 9a and is wrapped around rigging bollard 3 in the opposite counterclockwise direction to The secondary rigging line 9b is independent and separate from main rigging line 9a to the load 10 and prevents the unexpected loss of tension from self-tailing winch 2 created by the unwrapping of the main rigging line 9a from the drum of the winch.

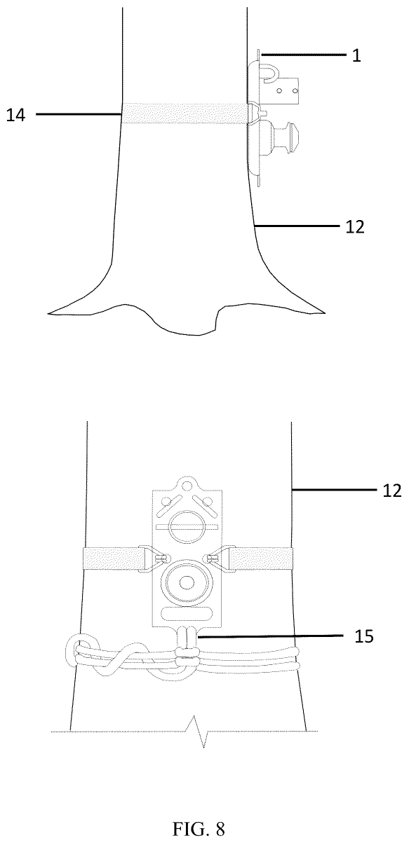

Other embodiments include one or more eyelets 6 positioned in optional positions in the rigging plate 1, but are not limited to, other ends of the rigging plate 1, between the self-tailing winch 2 and a rigging bollard 3, and other locations that are desired. A typical embodiment of eyelets 6 in FIG. 1 show one eyelet at the top of the rigging plate 1 relative to load 10, two adjacent to the fairleads 5, two oriented between and outside of the self-tailing winch 2 and a rigging bollard 3, and one eyelet at the bottom. As illustrated FIG. 2, the eyelets 6, and optionally the hand port 7, are used to attach a rachet strap, a cable, or a rigging line for anchoring and securing the self-tailing winch and rigging bollard device to a structure 12. FIG. 8 shows an example of anchoring to a tree. In the preferred embodiment, the size of a strap, rigging line, or cable encompasses or wraps around the entirety of the perimeter of the structure. Any structure 12 of the appropriate dimension and includes structures are made of wood, metal, plastic, or other compositions. A typical anchoring structure 12 includes, but are not limited to, a pole, tree, mast, beam, girder, or similar structure. In other embodiments, an accessory rigging tool, such as a pulley, can be attached using carabiners or fasteners to an eyelet 6 or the hand port opening 7.

The invention is anchored to a structure in a variety of ways to suitable structural points of the structure chosen by the operator, as exhibited in the illustration in FIG. 8. The rigging plate 1 is strapped to the stem or body of the structure using ratchet type straps 14, rated for heavy loads. Referring to the FIG. 8, the structure is a tree trunk in upper panel where the hooks of the straps are passed through two eyelets 6 in the rigging plate 1 and tightened securely around the anchoring trunk. In an additional embodiment of the anchoring rigging plate 1 is shown in the lower panel of FIG. 8. The eyelet 6 at the bottom of the rigging plate 1 is used to provide a second anchor point using an anchoring line 15 through eyelet 6 that is hitched to anchoring structure.

If one suitable anchor is not available for anchoring, a rope or sling can be passed through the hand port 7 at the bottom of the plate and terminated through the eyelets 6 located in the middle of the plate (FIG. 2). This anchoring configuration allows for attachment to the structure using multiple anchors and for use in horizontal applications where a suitable horizontal anchor exists. In horizontal applications, the load to be moved is in a horizontal position relative to the structure.

### Example 1: Rigging Line Routing to Rigging Winch

In FIG. 4, an example is depicted of using the main rigging line 9a to carefully raise, lower, or hold a load 10 using the self-tailing winch 2, without the use of the rigging bollard 3. The rigging line 11 is attached to the load 10 positioned above and vertical to the self-tailing winch 2. The rigging line 9a is passed over a solid support above the self-tailing winch and bollard device and then attached to the load 10. The rigging line 9a is routed outside the fairlead 5a, to the right side of rigging bollard 3. In the lower panel of FIG. 4, the rigging line 9a passes underneath the lower horizontal post 4a and the rigging plate 1, on the same side of the drum to be passed to the self-tailing winch 2. In FIG. 4, the rigging line 9a is wrapped clockwise around the drum 11 of the self-tailing winch 2 at least one time, and preferably three or more complete turns depending upon the weight of the load 10. The rigging line 9a is pulled taught to ensure the correct functioning of the self-tailing winch mechanism 13 and not hamper the movement of the lower self-tailing jaw, FIG. 4. The rigging line 9a is positioned over the self-tailing arm, whereby the self-tailing jaws adjust to the width of the rigging line. The rigging line 9a is locked off to begin tensioning of the line.

### Example 2: Rigging Line Routing to Rigging Bollard

In FIG. 6, an example is depicted of using a single rigging line 9b to safely raise, lower, or hold a load 10 using a single fairlead 5b, two horizontal posts 4, and the rigging bollard 3, without the use of self-tailing winch. The rigging line 9b is passed over a solid support above the self-tailing winch and bollard device and then attached to the load 10. The rigging line 9b is routed outside of the left fairlead 5b and then passes around the bottom of the rigging bollard 3. To hold a load 10, the rigging line 9b is pulled tight and wrapped once completely around the rigging bollard 3, between the lower horizontal post 4a and the rigging plate 1, as shown in FIG. 6. Depending upon the weight of the load 10, the rigging line 9b is wrapped two or more complete times around the rigging bollard 3, between the upper 4b and lower horizontal posts 4a and the load 10 is held in place by applying a cleat hitch on the upper horizontal posts 4b.

### Example 3: Two Rigging Lines Routing to Rigging Bollard and Rigging Winch

The use of two rigging lines, 9a and 9b, in FIG. 7 with the portable self-tailing winch and rigging bollard device offers a significant safety feature while moving heavy objects to prevent the unexpected falling of the heavy objects due to unwrapping of the rigging line from the rigging winch by having a second rigging line secured to the rigging bollard. In FIG. 7, an example is depicted of using two rigging lines, 9a and 9b, to first, safely hold a load 10 with one of the rigging lines 9b routed to the rigging bollard 3 as described in Example 2, and second, to use the second rigging line 9a routed to the self-tailing winch 2 as described in Example 1. In tandem, the fairleads separate the two rigging lines as each is routed outside the fairleads and provide additional tension point before routing to the rigging bollard or self-tailing winch to safely raise, lower, and move the load to the desired position while preventing an inadvertent falling of the load.

One such application is to cut a heavy limb safely off a tree. After the portable bollard and winch device is anchored to the tree trunk, one of the rigging lines is terminated at the limb to be cut and is passed through a rigging pulley above the load and then is routed to the rigging bollard and secured. Next, a second rigging line is terminated to the same limb at a different point and is passed through a second pulley above the load and routed to the rigging winch on the opposite side of the device. It is wrapped one or more times around the winch drum and set in the winch jaw mechanism. Once the rigging lines from the limb to the rigging bollard and to the rigging winch are securely in place, the limb is safely cut in the desired area between the tree and both rigging lines. After completing the cut, the limb can then be manipulated in space by adjusting tension of one or both rigging lines as needed, and is moved to the desired point to be placed.

Another application is in internal use in the construction of a large building. The portable self-tailing winch and rigging bollard device is anchored to a building column or similar support structure using a rachet strap, in this example. Both rigging lines, 9a and 9b, are passed over a truss in the roof and then the rigging lines are first secured to a building material to be moved upward. Next the lines are separately routed through the fairleads 5 on each side of rigging plate 1 of the device to either the rigging bollard 3 or the self-tailing winch 2. Once each rigging line is secured on the rigging bollard 3 or the self-tailing winch 2, the building material is safely raised using the dual lines to the position needed for the construction of the building.

1. A portable winch and bollard device comprising:
a) a rigging plate;
b) a winch, wherein the winch is permanently attached to the rigging plate;
c) a rigging bollard, wherein rigging bollard is permanently attached to the rigging plate; and
d) the winch and rigging bollard device is portable.

2. The portable winch and bollard device of claim 1, wherein the winch is a self-tailing winch.

3. The portable winch and bollard device of claim 1, wherein rigging plate contains one or more openings or eyelets.

4. The portable winch and bollard device of claim 3, wherein the openings or eyelets are used to attach a strap or a line, wherein the strap or the line securely anchors the rigging plate containing the winch and the rigging bollard to the structure.

5. The portable winch and bollard device of claim 1, wherein the rigging plate is composed of steel or titanium.

6. The portable winch and bollard device of claim 5, wherein the steel rigging plate is selected from a group consisting of stainless steel, carbon steel, galvanized, alloy, and steel variations.

7. The portable winch and bollard device of claim 1, wherein a longitudinal edge of rigging plate is rolled backward ranging from 35 to 90 degrees.

8. The portable winch and bollard device of claim 7, wherein the longitudinal edge of rigging plate is serrated.

9. The portable winch and bollard device of claim 1, wherein a position of the rigging bollard is located either directly above or below the winch in the vertical plane relative to the rigging plate.

10. The portable winch and bollard device of claim 1, wherein the rigging bollard is in a perpendicular position to the rigging plate.

11. The portable winch and bollard device of claim 1, wherein the rigging bollard is a hollow or solid metal tube.

12. The portable winch and bollard device of claim 11, wherein the rigging bollard is composed of steel or titanium.

13. The portable winch and bollard device of claim 1, further comprising a fairlead that is permanently attached to the rigging plate adjacent and outside of the rigging bollard on the rigging plate.

14. The portable winch and bollard device of claim 13, further comprising a second fairlead that is permanently attached on the opposite side of the rigging plate to the first fairlead and adjacent and outside of the rigging bollard.

15. The portable winch and bollard device of claim 13, wherein the fairlead is positioned at least the distance of a diameter of a rigging line from the rigging bollard.

16. The portable winch and bollard device of claim 1, wherein a post is inserted in the rigging bollard in a horizontal position to the rigging plate and perpendicular to the self-tailing winch.

17. The portable winch and bollard device of claim 16, wherein a second post is inserted in the rigging bollard in a horizontal position to the rigging plate and parallel to the first horizontal post.

18. A portable winch and bollard device method to safely move a load using two rigging lines without obstructing each other, comprising:
a) anchoring the rigging plate of the portable winch and bollard device to a structure using eyelets or openings with a strap or a line, wherein a winch and a rigging bollard are permanently attached to the rigging plate of the portable winch and bollard device;
b) securing the two rigging lines to the load;
c) passing the rigging lines over a support above the portable winch and bollard device;
d) routing a first rigging line outside a fairlead and the rigging bollard toward the winch on the device;
e) wrapping the first rigging line around the drum of the winch, wherein the first rigging line is secured or unsecured;
f) routing a second rigging line outside the second fairlead on the opposite side and around the rigging bollard;
g) wrapping the second rigging line around the rigging bollard, wherein the second rigging line is secured or unsecured; and
h) advancing the winch to tension the first rigging line to securely raise, to lower, or to hold the load, wherein the second rigging line is used with the first rigging line to safely move the load.

19. The portable winch and bollard device of claim 14, wherein the fairlead is positioned at least the distance of a diameter of a rigging line from the rigging bollard.
